(19) United States
(12) Patent Application Publication
(10) Pub. No.: US 2025/0319759 A1
(43) Pub. Date: Oct. 16, 2025

(54) TECHNIQUES FOR REAL-TIME ENERGY CONSUMPTION OPTIMIZATION IN HYBRID ELECTRIC VEHICLES

(71) Applicant: FCA US LLC, Auburn Hills, MI (US)

(72) Inventors: Xi Chen, Shanghai (CN); Quan Gan, Shanghai (CN); Lin Wang, Shanghai (CN); Jieyun Wu, Shanghai (CN); Gang Wang, Shanghai (CN)

(21) Appl. No.: 18/635,358

(22) Filed: Apr. 15, 2024

(51) Int. Cl. B60K 6/28; B60K 6/24; B60K 6/26

(52) U.S. Cl. CPC B60K 6/28; B60K 6/24; B60K 2006/268

(57) ABSTRACT

An energy consumption optimization method for a hybrid electric vehicle (HEV) having a hybrid powertrain includes obtaining a plurality of operating parameters of the hybrid powertrain, the hybrid powertrain comprising one or more electric traction motors powered by a battery system and an engine configured to drive the HEV and selectively recharge the battery system, obtaining trip information indicative of a length or duration of a current trip of the HEV, determining a remaining energy in the battery system based on the plurality of operating parameters of the hybrid powertrain, determining a trip energy needed for the hybrid powertrain to complete the current trip of the HEV based on a plurality of operating parameters of the hybrid powertrain and the trip information, comparing the remaining energy in the battery system to the trip energy, and controlling operation of the hybrid powertrain based on the comparing.

### FIELD

The present application generally relates to hybrid electric vehicles (HEVs) and, more particularly, to techniques for real-time energy consumption optimization in HEVs.

### BACKGROUND

A hybrid electric vehicle (HEV) includes a hybrid powertrain having multiple energy sources. For example, (1) a high-voltage battery system stores and provides electrical energy (current) to one or more electric traction motors for vehicle propulsion and (2) a fuel system stores and provides liquid fuel (gasoline, diesel, etc.) to an internal combustion engine for combustion of a fuel/air mixture to generate torque. The torque generated by the engine could be used for either vehicle propulsion or for recharging the battery system (e.g., via an intermediary motor-generator unit, or MGU). Electric motors are typically two to three times more efficient than an engine, thus making motor/battery system based propulsion a priority. Depending on a duration/length of a customer vehicle trip, however, the battery may be unable to fully satisfy the needed propulsive energy for the entire vehicle trip. Accordingly, while such conventional HEV hybrid powertrains do work for their intended purpose, there exists an opportunity for improvement in the relevant art.

### SUMMARY

According to one example aspect of the invention, an energy consumption optimization system for a hybrid electric vehicle (HEV) having a hybrid powertrain is presented. In one exemplary implementation, the energy consumption optimization system comprises a set of sensors configured to monitor a plurality of operating parameters of the hybrid powertrain, the hybrid powertrain comprising one or more electric traction motors powered by a battery system and an engine configured to selectively recharge the battery system and drive the HEV and a control system configured to receive, from the set of sensors, the plurality of operating parameters of the hybrid powertrain, obtain trip information indicative of a length or duration of a current trip of the HEV, determine, based on the plurality of operating parameters of the hybrid powertrain, a remaining energy in the battery system, determine, based on the plurality of operating parameters of the hybrid powertrain and the trip information, a trip energy needed for the hybrid powertrain to complete the current trip of the HEV, compare the remaining energy in the battery system to the trip energy, and control operation of the hybrid powertrain based on the comparison.

In some implementations, when the remaining energy in the battery system is less than the trip energy, the control system is configured to temporarily operate the engine on to drive the HEV and to selectively recharge the battery system while satisfying a driver torque request. In some implementations, the control system is configured to utilize a calibrated look-up table or multi-dimensional surface to determine an engine/ZEV split for controlling the hybrid powertrain. In some implementations, the control system is configured to operate the engine in a maximum efficiency region. In some implementations, the control system is configured to control the one or more electric motors and selectively operate engine on to satisfy the driver torque request based further on a speed of the HEV.

In some implementations, when the remaining energy in the battery system is greater than or equal to the trip energy, the control system is configured to control the hybrid powertrain to satisfy the driver torque request using the battery system and the one or more electric motors and not starting the engine to drive the HEV and to selectively recharge the battery system. In some implementations, the control system is further configured to determine a current state of charge (SOC) of the battery system, determine a target SOC for the battery system at the end of the current trip of the HEV, and determine the remaining energy in the battery system based on a difference between its current and target SOCs. In some implementations, the control system is configured to determine the current SOC of the battery system using an SOC model having other parameters as inputs thereto. In some implementations, the control system is configured to obtain at least a portion of the trip information from a maps/navigation system of the HEV. In some implementations, the control system is configured to intelligently predict at least a portion of the trip information based on past driving history/behavior.

According to another example aspect of the invention, an energy consumption optimization method for an HEV having a hybrid powertrain is presented. In one exemplary implementation, the energy consumption optimization method comprises obtaining, by a control system of the HEV and using a set of sensors of the HEV, a plurality of operating parameters of the hybrid powertrain, the hybrid powertrain comprising one or more electric traction motors powered by a battery system and an engine configured to drive the HEV and selectively recharge the battery system, obtaining, by the control system, trip information indicative of a length or duration of a current trip of the HEV, determining, by the control system, a remaining energy in the battery system based on the plurality of operating parameters of the hybrid powertrain, determining, by the control system, a trip energy needed for the hybrid powertrain to complete the current trip of the HEV based on the plurality of operating parameters of the hybrid powertrain and the trip information, comparing, by the control system, the remaining energy in the battery system to the trip energy, and controlling, by the control system, operation of the hybrid powertrain based on the comparing.

In some implementations, controlling operation of the hybrid powertrain based on the comparing further comprises, when the remaining energy in the battery system is less than the trip energy, temporarily operating the engine on to drive the HEV and to selectively recharge the battery system while satisfying a driver torque request. In some implementations, the method further comprises utilizing, by the control system, a calibrated look-up table or multi-dimensional surface to determine an engine/ZEV split for controlling the hybrid powertrain. In some implementations, temporarily operating the engine further comprises temporarily operating the engine in a maximum efficiency region. In some implementations, controlling the one or more electric motors to satisfy the driver torque request is based further on a speed of the HEV.

In some implementations, controlling operation of the hybrid powertrain based on the comparing further comprises, when the remaining energy in the battery system is greater than or equal to the trip energy, controlling the hybrid powertrain to satisfy the driver torque request using the battery system and the one or more electric motors and not starting the engine to drive the HEV and to selectively recharge the battery system. In some implementations, the method further comprises determining, by the control system, a current SOC of the battery system, determining, by the control system, a target SOC for the battery system at the end of the current trip of the HEV, and determining, by the control system, the remaining energy in the battery system based on a difference between its current and target SOCs. In some implementations, the control system is configured to determine the current SOC of the battery system using an SOC model having other parameters as inputs thereto. In some implementations, obtaining the trip information further comprises obtaining, by the control system, at least a portion of the trip information from a maps/navigation system of the HEV. In some implementations, obtaining the trip information further comprises intelligently predicting, by the control system, at least a portion of the trip information based on past driving history/behavior.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are efficiency plots illustrating efficiencies of an example electric motor and an example internal combustion engine;

FIG. 1C is plot illustrating an engine on/ZEV split line according to the principles of the present application;

FIG. 2 is a functional block diagram of a hybrid electric vehicle (HEV) having an example engine consumption optimization system according to the principles of the present application;

FIGS. 3A-3C are plots of vehicle speed, road load contribution to vehicle demanded energy (VDE), and inertial (vehicle mass) contribution to VDE over an example vehicle trip according to the principles of the present application;

FIG. 3D is a plot of example battery system state of charge (SOC) over an example vehicle city cycle both with and without the optimization techniques and engine on/off operation over an example vehicle city cycle according to the principles of the present application; and

FIG. 4 is a flow diagram of an example energy consumption optimization method for a hybrid powertrain of an HEV according to the principles of the present application.

### DESCRIPTION

As previously discussed, a hybrid powertrain of a hybrid electric vehicle (HEV) typically has two different energy sources: (1) a high-voltage battery system configured to store and provide electric energy to one or more electric traction motors and (2) a fuel system configured to store and provide liquid fuel (gasoline, diesel, etc.) to the internal combustion engine. Electric motors, including any related inverter losses, are typically two to three times more efficient than an engine, thus making motor/battery system based propulsion a priority. Depending on a duration/length of the current vehicle trip, however, the energy of the battery system may be unable to fully satisfy the needed propulsive power for the entire vehicle trip. Thus, when the state of charge (SOC) of the battery system reaches a low/minimum level or threshold, the other energy source (i.e., the liquid fuel for powering the engine) must be utilized either to propulsively power the HEV or to recharge the battery system. Conventional solutions to this problem include choosing from a select few predetermined or predefined curves for engine/ZEV split control (e.g., high SOC calibration, normal HEV calibration, low SOC calibration), but these curves are limited and cannot be adjusted based on the entire vehicle trip length/duration and in real-time.

Accordingly, techniques are presented herein that optimize energy consumption in a HEV in real-time. This optimization is based on the entire vehicle trip, which could be ascertained using a maps or navigation system of the HEV. The optimization techniques determine, at each time step/interval during the vehicle trip, a current SOC (SOC_{CUR}) and a target SOC (SOC_{TGT}) and then calculate a remaining energy (E_{REM}) of the battery system based on an SOC difference SOC_{DIF} (e.g., SOC_{CUR}−SOC_{TGT}). When there is sufficient remaining energy in the battery system for the remainder of the vehicle trip (E_{REM}≥E_{TRIP}), there is no change and electric-only propulsion (ZEV) is used. However, when the remaining energy E_{REM} is insufficient (E_{REM}<E_{TRIP}), an engine/ZEV split line or surface is utilized to determine when to use ZEV to cover for the engine at its inefficient operating points/regions while also using up all of the remaining energy E_{REM} by the end of the vehicle trip. Compared to the conventional solutions described above, these real-time energy consumption optimization techniques provide for real-time (on-the-fly) adjustment of engine/ZEV split operation based on the entire vehicle trip length/duration and to complete the vehicle trip with as little stored electrical energy as possible (e.g., near 0% or a minimum SOC level).

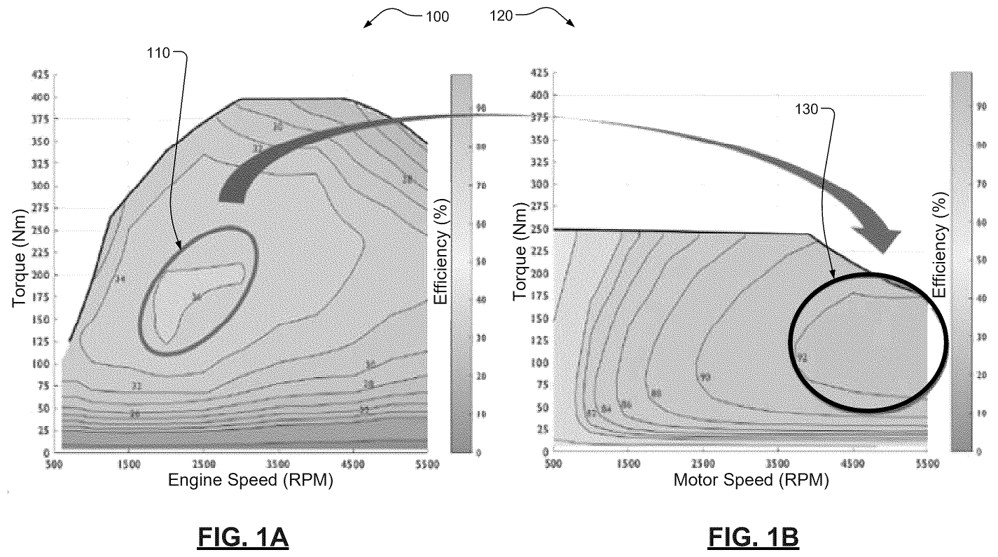

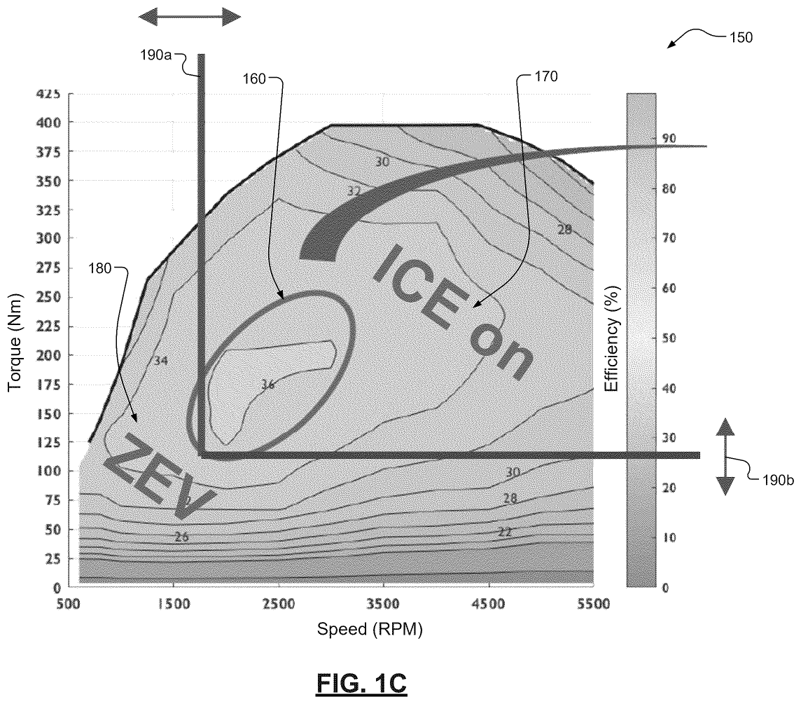

Referring now to FIGS. 1A-1B, efficiency plots 100, 120 illustrating efficiencies of an example electric motor and an example internal combustion engine according to the principles of the present application are illustrated. In the left plot 100 depicting efficiency of an example internal combustion engine, it can be seen that the engine is relatively inefficient across most of its operating regions. In a best or most efficient operating region 110, the peak engine efficiency is approximately 35-40%. In contrast, in the right plot 120 depicting efficiency of an example electric motor, it can be seen that the electric motor is very efficient across all of its operating regions (at least in comparison to the engine). In a best or most efficient operating region 130, the peak electric motor efficiency is approximately 90-95%, including any associated inverter losses. The term “inverter losses” refers to switching losses by an inverter that generates three-phase AC currents for powering the electric motor from a single DC supply current. Because the electric motor, including any inverter losses, is two to three times more efficient than the engine, utilization of the motor/battery system for vehicle propulsion will be prioritized in an effort to maximize vehicle efficiency and maximize or increase vehicle fuel economy.

Referring now to FIG. 1C, another efficiency plot 150 illustrating an efficiency of an example internal combustion engine and an engine/ZEV split line 190a-190b according to the principles of the present application is illustrated. This split line 190a-190b can be calculated in real-time based on remaining energy and information for a remainder of the current trip. As shown, in the best or most efficient operating region 160, the peak efficiency of the engine is approximately 35-40%. The electric motor(s) and the battery system are capable of being utilized to compensate for the inefficiencies of the engine. As shown, below engine/motor split line 190a-190b, only the electric motor(s) are utilized and the engine is off or not running (also known as an electric vehicle or “ZEV” mode). Above the engine/motor split line 190a-190b, the engine is on/running for vehicle propulsion. This plot 150 could be stored as an LUT or multi-dimensional (e.g., two-dimensional, or 2D) surface and later accessed (e.g., from a local or remote memory) as part of the techniques of the present application, which will be discussed in greater detail below.

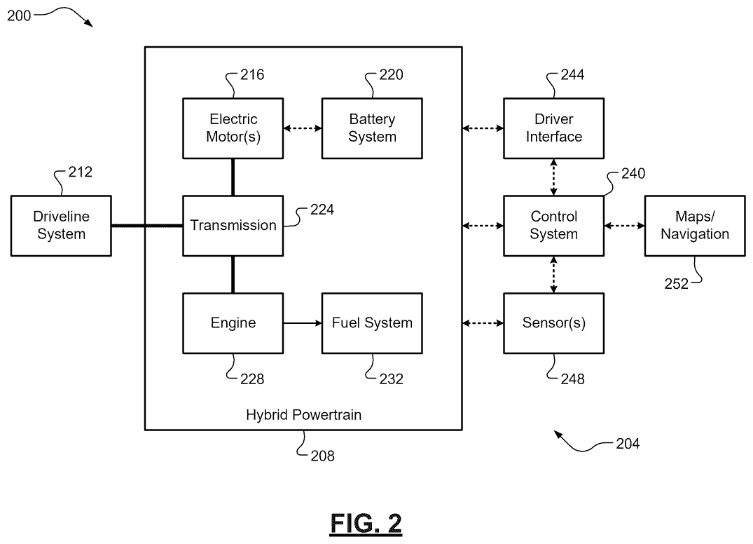

Referring now to FIG. 2, a functional block diagram of a an HEV 200 having an example engine or energy consumption optimization system 204 according to the principles of the present application is illustrated. In one exemplary implementation, the HEV 200 is a plug-in HEV (PHEV) that is capable of battery system recharging via an external power source and a charging port/system (not shown). The HEV 200 comprises a hybrid powertrain 208 configured to generate and transfer drive torque to a driveline system 212 (half shafts or axles, a differential, etc.) for vehicle propulsion. The hybrid powertrain 208 includes one or more electric traction motors 216 that are powered by electrical energy (current) provided by a high-voltage battery pack or system 220. A transmission 224, such as a multi-speed automatic transmission, is configured to transfer the drive torque generated by the electric motor(s) 216 or an internal combustion engine 228 to the driveline system 212. It will be appreciated that the hybrid powertrain 208 could potentially have other suitable hybrid configurations.

A controller or control system 240 controls operation of the HEV 200. In particular, the control system 240 controls the hybrid powertrain 208 to generate and transfer a desired amount of drive torque to the driveline system 212 to satisfy a driver torque request, which could be input by a driver of the HEV 200 via a driver interface 244 (e.g., an accelerator pedal). The HEV 100 includes a set of one or more sensors 248 that are configured to monitor/measure various operating parameters of the HEV 100 including, but not limited to, rotating shaft positions/speeds, temperatures, and air/fluid pressures. The sensor(s) 248 could include an SOC sensor configured to measure an SOC of the battery system 220, but it will be appreciated that the SOC of the battery system 220 could also be modeled based on other measured/known parameters. The control system 240 is also configured to perform at least a portion of the energy consumption optimization techniques of the present application, including obtaining trip information from a maps/navigation system 252. These operations could also include, for example, determining current and target SOC values (SOC_{CUR} and SOC_{TGT}) for the battery system 120, calculating the remaining energy and trip completion energy values (E_{REM} and E_{TRIP}), and controlling the hybrid powertrain 108 (e.g., an operating mode-motor-only ZEV or hybrid, i.e., motor and engine).

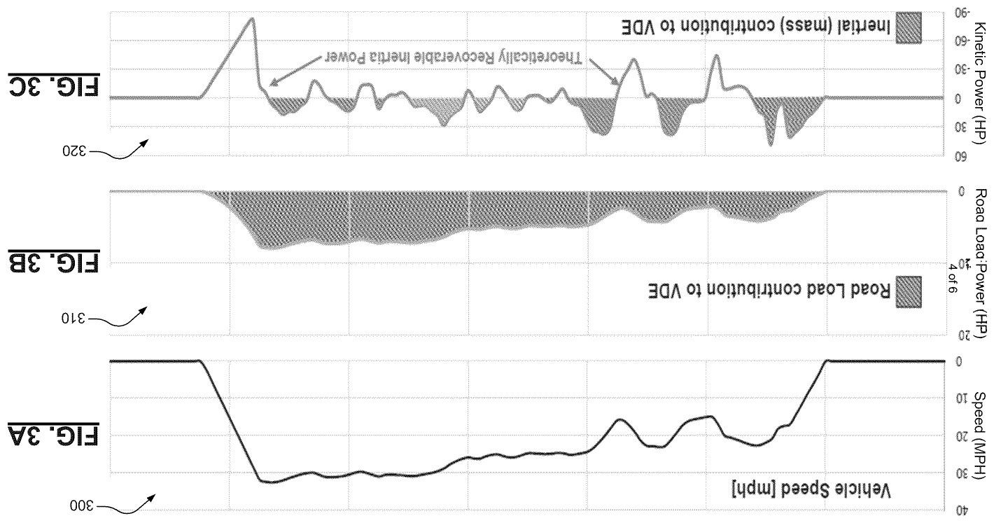

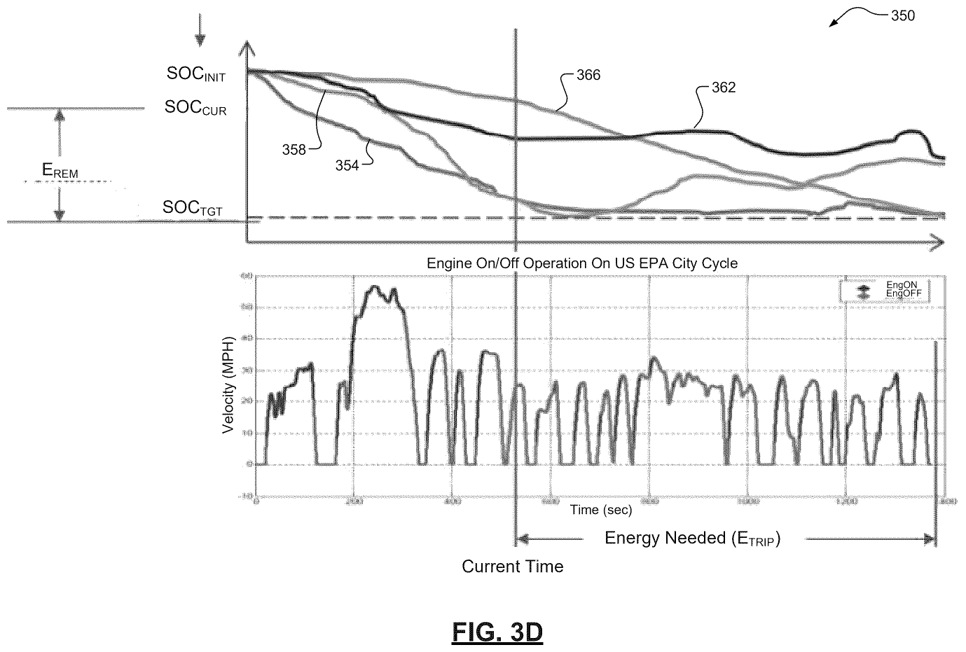

Referring now to FIGS. 3A-3C, plots 300, 310, and 320 of vehicle speed, road load contribution to vehicle demanded energy (VDE), and inertial (vehicle mass) contribution to VDE, respectively, over an example vehicle trip according to the principles of the present application are illustrated. As shown in plot 300 of FIG. 3A, the vehicle trip begins with a substantial acceleration of the vehicle to ˜25 miles per hour (mph or MPH). Thereafter, the vehicle trip continues with small decelerations and accelerations before a final deceleration from >30 MPH to 0 MPH at an end of the vehicle trip. In plot 310 of FIG. 3B, the road load contribution to the VDE (i.e., road load power, in horsepower or HP) is shown. This represents the amount of power the vehicle must generate in order to achieve the vehicle speed profile of FIG. 3A along the current road (e.g., having a particular grade/slope and frictional properties). Finally, in plot 320 of FIG. 3C, the inertial mass (vehicle mass) contribution to the VDE is illustrated. This represents the kinetic power (in HP) of the vehicle during the vehicle trip. For example, when the vehicle is decelerating and/or traveling down downhill grades, the vehicle has kinetic energy and, when the kinetic power is negative (less than zero), there is vehicle kinetic energy that is potentially recoverable (e.g., for recharging the battery system via the electric motor(s) 216 or a separate regenerative braking system).

Referring now to FIG. 3D, a plot 350 of example battery system SOC over an example vehicle city cycle both with and without the optimization techniques according to the principles of the present application is illustrated. As shown, the example vehicle city cycle is one created or specified by the United States Environmental Protection Agency (EPA) and includes various engine on/off periods during an example vehicle city driving cycle. The top portion of plot 350 illustrates the battery system SOC, which ranges from an initial SOC (SOC_{INIT}) down to SOC_{TGT} (e.g., a minimum SOC level/threshold) at the end of the vehicle trip. SOC curves 354-362 illustrate control of the hybrid powertrain with no energy consumption optimization (curve 354) and using conventional predetermined or predefined energy consumption optimization data (curves 358 and 362) according to the prior art and as previously described herein. Curve 366, on the other hand, represents the energy consumption optimization and corresponding hybrid powertrain control according to the techniques of the present application. As can be seen, the battery system energy is better maintained throughout the vehicle trip and does not include any significant drops followed by subsequent engine-on recharging periods/operations. In curve 366, the battery system SOC is also fully depleted (to SOC_{TGT}) at the end of the vehicle trip in contrast to the conventional prior art solutions (curves 358 and 366) where battery system energy remains.

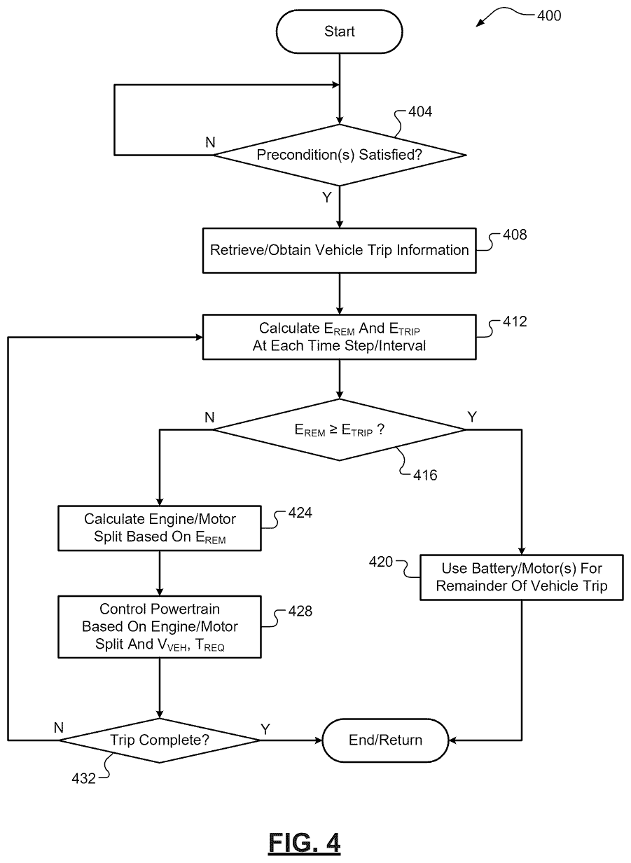

Referring now to FIG. 4, a flow diagram of an example energy consumption optimization method 400 for a hybrid powertrain of an HEV according to the principles of the present application. While the HEV 200 and its components are specifically references for illustrative/descriptive purposes, it will be appreciated that the method 400 could be applicable to any suitably configured HEV or vehicle having a suitably configured hybrid powertrain.

At 404, the control system 240 determines whether an optional set of one or more preconditions are satisfied. This could include, for example only, the hybrid powertrain 208 being powered up and running and there being no malfunctions or faults present that would otherwise inhibit or negatively impact the operation of the energy consumption optimization techniques of the present application. When false, the method 400 ends or returns to 404. When true, the method 400 proceeds to 408. At 408, the control system 240 determines (e.g., gathers or collects) trip information for the current trip of the HEV 200. This could be obtained, for example, from the maps/navigation system 252 of the HEV 200. For example, the driver of the HEV 200 may have selected a final endpoint or destination for the current trip. This could also include some predictive action by the control system 140, such as predicting a likely endpoint or destination of the HEV 200 for the current trip based on various parameters (e.g., past driving history/habits of the driver). For example, the driver may take the same commute between her/his home and her/his workplace at the same times on the same days (e.g., weekdays).

At 412, the control system 240 calculates, at each time step/interval, the remaining energy E_{REM} based on the SOC of the battery system 220. More specifically, the control system 240 is configured to calculate the remaining energy based on a difference SOC_{DIF} between the actual (at current time) or modeled SOC_{CUR} and the final SOC_{TGT}. At 416, the control system 240 determines whether the remaining energy E_{REM} exceeds a needed or necessary energy E_{TRIP} to complete the vehicle trip in electric-only (ZEV) mode (i.e., whether E_{REM}≥ E_{TRIP}). The time step/interval represents a predetermined determination period in which the control system 240 continues to recalculate the remaining energy E_{REM} until a true/yes determination is made that the remainder of the vehicle trip can be completed in the electric-only (BEV) mode, which may never occur before the vehicle trip ends. When 416 is true/yes, the method 400 proceeds to 420 where the control system 240 uses the battery system 220 and the electric motor(s) 216 to satisfy the powertrain torque requests (electric-only or ZEV mode) for the remainder of the current trip and the method 400 then ends or returns to 404. When 416 is false/no, the method 400 proceeds to 424.

At 424, the control system 240 calculates or determines an engine/ZEV split based on the remaining energy E_{REM}. This could include, for example, accessing a calibrated LUT or surface similar to the plot 150 depicted in FIG. 1C. At 428, the control system 240 controls the hybrid powertrain 208 according to the desired engine/ZEV split or mode for the hybrid powertrain 208. This could include, for example only, controlling the engine 228 to operate to generate drive torque based on a driver torque request (T_{REQ}) and a velocity of the vehicle (V_{VEH}), such as a front axle rotational speed. At 432, the control system 240 determines whether the current trip of the HEV 200 has completed. When true, the method 400 ends or returns to 404. When false, the method 400 ends and returns to 412 for another time step/interval calculation process or cycle. For example, the operation of the engine 228 at steps 424-428 could have resulted in the remaining energy E_{REM} now exceeding E_{TRIP}.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An energy consumption optimization system for a hybrid electric vehicle (HEV) having a hybrid powertrain, the energy consumption optimization system comprising:
a set of sensors configured to monitor a plurality of operating parameters of the hybrid powertrain, the hybrid powertrain comprising one or more electric traction motors powered by a battery system and an engine configured to selectively recharge the battery system and drive the HEV; and
a control system configured to:
receive, from the set of sensors, the plurality of operating parameters of the hybrid powertrain;
obtain trip information indicative of a length or duration of a current trip of the HEV;
determine, based on the plurality of operating parameters of the hybrid powertrain, a remaining energy in the battery system;
determine, based on the plurality of operating parameters of the hybrid powertrain and the trip information, a trip energy needed for the hybrid powertrain to complete the current trip of the HEV;
compare the remaining energy in the battery system to the trip energy; and
control operation of the hybrid powertrain based on the comparison.

2. The energy consumption optimization system of claim 1, wherein when the remaining energy in the battery system is less than the trip energy, the control system is configured to temporarily operate the engine on to drive the HEV and to selectively recharge the battery system while satisfying a driver torque request.

3. The energy consumption optimization system of claim 2, wherein the control system is configured to utilize a calibrated look-up table or multi-dimensional surface to determine an engine/ZEV split for controlling the hybrid powertrain.

4. The energy consumption optimization system of claim 3, wherein the control system is configured to operate the engine in a maximum efficiency region.

5. The energy consumption optimization system of claim 4, wherein the control system is configured to control the one or more electric motors and selectively operate engine on to satisfy the driver torque request based further on a speed of the HEV.

6. The energy consumption optimization system of claim 2, wherein when the remaining energy in the battery system is greater than or equal to the trip energy, the control system is configured to control the hybrid powertrain to satisfy the driver torque request using the battery system and the one or more electric motors and not starting the engine to drive the HEV and to selectively recharge the battery system.

7. The energy consumption optimization system of claim 1, wherein the control system is further configured to:
determine a current state of charge (SOC) of the battery system;
determine a target SOC for the battery system at the end of the current trip of the HEV; and
determine the remaining energy in the battery system based on a difference between its current and target SOCs.

8. The energy consumption optimization system of claim 7, wherein the control system is configured to determine the current SOC of the battery system using an SOC model having other parameters as inputs thereto.

9. The energy consumption optimization system of claim 1, wherein the control system is configured to obtain at least a portion of the trip information from a maps/navigation system of the HEV.

10. The energy consumption optimization system of claim 1, wherein the control system is configured to intelligently predict at least a portion of the trip information based on past driving history/behavior.

11. An energy consumption optimization method for a hybrid electric vehicle (HEV) having a hybrid powertrain, the energy consumption optimization method comprising:
obtaining, by a control system of the HEV and using a set of sensors of the HEV, a plurality of operating parameters of the hybrid powertrain, the hybrid powertrain comprising one or more electric traction motors powered by a battery system and an engine configured to drive the HEV and selectively recharge the battery system;
obtaining, by the control system, trip information indicative of a length or duration of a current trip of the HEV;
determining, by the control system, a remaining energy in the battery system based on the plurality of operating parameters of the hybrid powertrain;
determining, by the control system, a trip energy needed for the hybrid powertrain to complete the current trip of the HEV based on the plurality of operating parameters of the hybrid powertrain and the trip information;
comparing, by the control system, the remaining energy in the battery system to the trip energy; and
controlling, by the control system, operation of the hybrid powertrain based on the comparing.

12. The energy consumption optimization method of claim 11, wherein controlling operation of the hybrid powertrain based on the comparing further comprises, when the remaining energy in the battery system is less than the trip energy, temporarily operating the engine on to drive the HEV and to selectively recharge the battery system while satisfying a driver torque request.

13. The energy consumption optimization method of claim 12, further comprising utilizing, by the control system, a calibrated look-up table or multi-dimensional surface to determine an engine/ZEV split for controlling the hybrid powertrain.

14. The energy consumption optimization method of claim 13, wherein temporarily operating the engine further comprises temporarily operating the engine in a maximum efficiency region.

15. The energy consumption optimization method of claim 14, wherein controlling the one or more electric motors to satisfy the driver torque request is based further on a speed of the HEV.

16. The energy consumption optimization method of claim 12, wherein controlling operation of the hybrid powertrain based on the comparing further comprises, when the remaining energy in the battery system is greater than or equal to the trip energy, controlling the hybrid powertrain to satisfy the driver torque request using the battery system and the one or more electric motors and not starting the engine to drive the HEV and to selectively recharge the battery system.

17. The energy consumption optimization method of claim 11, further comprising:
determining, by the control system, a current state of charge (SOC) of the battery system;
determining, by the control system, a target SOC for the battery system at the end of the current trip of the HEV; and
determining, by the control system, the remaining energy in the battery system based on a difference between its current and target SOCs.

18. The energy consumption optimization method of claim 17, wherein the control system is configured to determine the current SOC of the battery system using an SOC model having other parameters as inputs thereto.

19. The energy consumption optimization method of claim 11, wherein obtaining the trip information further comprises obtaining, by the control system, at least a portion of the trip information from a maps/navigation system of the HEV.

20. The energy consumption optimization method of claim 11, wherein obtaining the trip information further comprises intelligently predicting, by the control system, at least a portion of the trip information based on past driving history/behavior.
